(19) United States
(12) Patent Application Publication
(10) Pub. No.: US 2015/0112995 A1
(43) Pub. Date: Apr. 23, 2015

(54) INFORMATION RETRIEVAL FOR GROUP USERS

(71) Applicant: Microsoft Corporation, Redmond, WA (US)

(72) Inventors: Oded Elyada, Kfar Saba (IL); Kfir Karmon, Petach Tikva (IL); Avigad Oron, Tel Aviv (IL)

(73) Assignee: Microsoft Corporation, Redmond, WA (US)

(21) Appl. No.: 14/057,406

(22) Filed: Oct. 18, 2013

(51) Int. Cl. G06F 17/30; H04L 29/06; H04L 12/58; H04L 12/26

(52) U.S. Cl. CPC G06F 17/3053; H04L 43/08; G06F 17/30598; H04L 65/403; H04L 51/32
USPC 707/738

(57) ABSTRACT

Information retrieval for group users is described, for example, where an end user of a group, such as an enterprise or other organization, is able to identify and contact other end users of the group who have association with a query the end user issues. In various examples, topics associated with a query of an end user, or of queries of an enterprise or other group, are found. In examples, end users are associated with the topics. In various examples information about end users associated with a topic is displayed at a graphical user interface of an information retrieval system. In various examples an end user is able to send the query and/or a message to end users who have association with the query and/or a topic by making input at a graphical user interface of the information retrieval system. In some examples, notes and sharing permissions are stored.

### BACKGROUND

Existing internet search engines are designed for use by the general public and give results from around the internet. In contrast, many intranet search engines are used today within enterprises, organizations and other groups of users. The intranet search engines are tailored for use by individuals within the particular enterprise, organization or other group. Federated information retrieval systems are known which search both interne and intranet sources and then merge the results before presenting the results to an end user.

Information workers, who are individuals that use information retrieval systems as part of their work in order to solve problems, answer questions, carry out research and for other tasks, often spend large amounts of time operating information retrieval systems. For example, six or more hours a week per information worker. This is a significant amount of time and there is an ongoing need to improve information retrieval systems to enable information workers to complete tasks more quickly. This also applies with regard to any end user of information retrieval systems.

The embodiments described below are not limited to implementations which solve any or all of the disadvantages of known information retrieval systems.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Information retrieval for group users is described, for example, where an end user of a group, such as an enterprise or other organization, is able to identify and contact other end users of the group who have association with a query the end user issues. In various examples, topics associated with a query of an end user, or of queries of an enterprise or other group, are found. In various examples, end users are associated with the topics. In various examples information about end users associated with a topic is displayed at a graphical user interface of an information retrieval system. In various examples an end user is able to send the query and/or a message to end users who have association with the query and/or a topic by making input at a graphical user interface of the information retrieval system. In some examples, notes and sharing permissions are stored.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a graphical user interface display of an information retrieval system with group sharing and showing results including end user results;

FIG. 2 is a schematic diagram of the graphical user interface display of FIG. 1 with a pop up detail;

FIG. 3 is a schematic diagram of a graphical user interface display for leaving a note and specifying sharing permissions;

FIG. 4 is a schematic diagram of an enterprise network, suitable for implementing the graphical user interface display of FIGS. 1 and 2, connected via a firewall to a public communications network;

FIG. 5 is a flow diagram of a method at an information retrieval system;

FIG. 6 is a flow diagram of three methods at an information retrieval system;

FIG. 7 is a flow diagram of a method of query modification;

FIG. 8 is a flow diagram of a method of obtaining data to be shared and of storing associated sharing permissions;

FIG. 9 is a schematic diagram of inputs to a topic analysis component;

FIG. 10 illustrates an exemplary computing-based device in which embodiments of an information retrieval system may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an enterprise information retrieval system, the system described is provided as an example and not a limitation. As those skilled in the art will appreciate, the present examples are suitable for application in a variety of different types of information retrieval systems, including but not limited to those enabling groups of users to share information and collaborate.

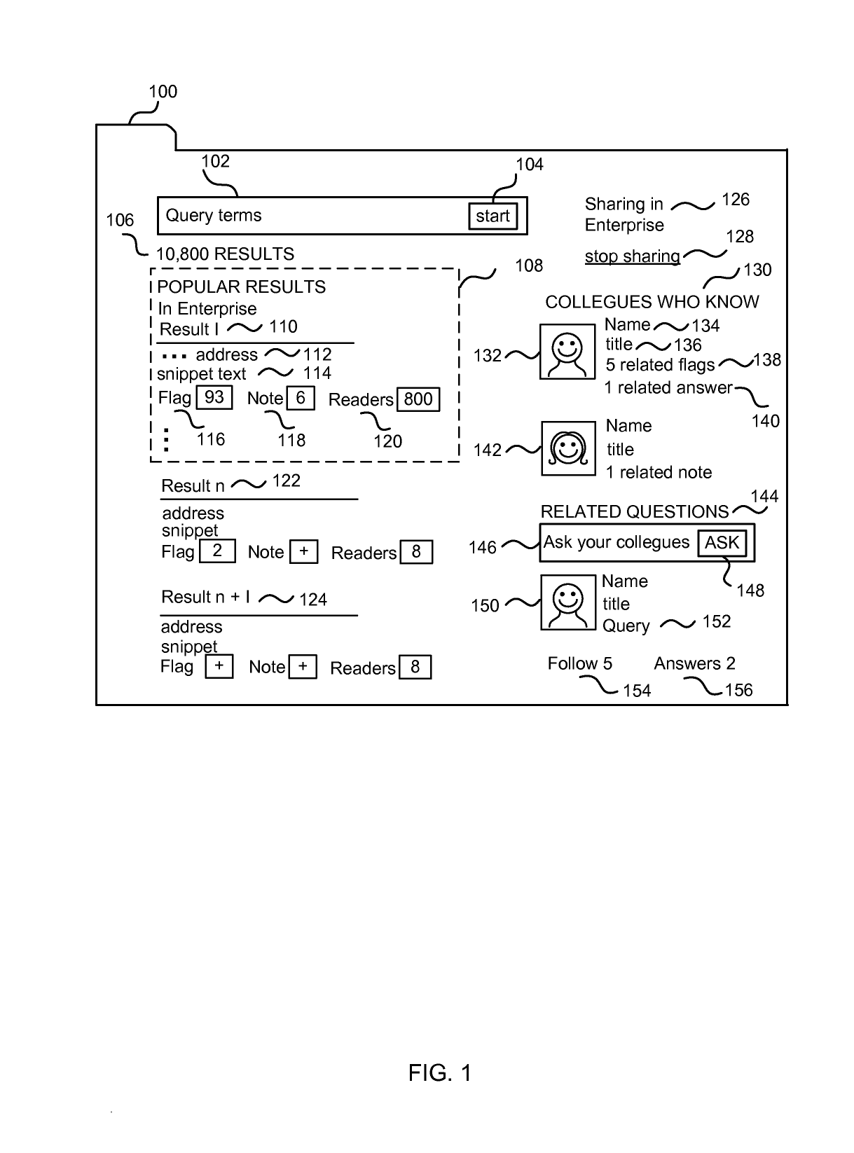

FIG. 1 is a schematic diagram of a graphical user interface display 100 (such as a search home page) of an information retrieval system with group sharing 126 and showing results 108, 122, 124, 132, 142, 150 including end user results 132, 142, 150. In some embodiments a user is able to select whether he or she wants to use group sharing or not (on a per-interaction basis if desired). In other embodiments, group sharing functionality is enabled continually where end users have given consent. In examples end users have access to a repository storing end user records. The end user records comprise end user information such as topics an end user is found to have expertise on, the topics having been found as a result of the group sharing functionality. End users may selectively remove data from their end user records.

In the example of FIG. 1 an end user has selected an option to enable sharing within an enterprise at which he or she works. This is indicated by the “sharing in Enterprise” display 126 at the graphical user interface. To disable the sharing option the end user is able to select a “stop sharing” link 128. Where the information retrieval system is linked to one or more other systems including but not limited to: an enterprise portal, an enterprise management reporting system, an enterprise social network; the other systems may display graphical user interfaces enabling an end user to enable or disable the sharing functionality.

When group sharing is enabled (either by the end user selecting this option on a per interaction basis, or in other ways) the information retrieval system uses data about end users within the Enterprise, who have given consent for their data to be shared within the Enterprise. When the sharing option is enabled end users are able to share information and collaborate using the information retrieval system. Data about an end user may comprise name, job title, role in enterprise, contact details, projects the end user is working on, a photograph of the end user, topics associated with the end user, past queries issued by the end user to the information retrieval system, notes created by the end user, answers the end user has given to questions submitted via the information retrieval system, flags assigned to the end user, hobbies of the end user.

The information retrieval system comprises a topic analysis component which is described in more detail later. The topic analysis component takes data from the information retrieval system and/or other sources and finds topics. A topic may be a person, place, time, animal, object, game, category or any other subject including enterprise specific terms and projects. The topic analysis component also allocates end users to topics. In some examples a taxonomy related to the line of business the enterprise is in is used to create topics. For example, for a software business the topics may include: a programming language, a programming paradigm, a programming tool, a name of a technology, a name of a software product.

An end user is able to enter query terms at entry box 102. When a user selects start button 104 any query terms which are in entry box 102 are sent to an information retrieval system. The information retrieval system uses data from the topic analysis component. The information retrieval system returns a ranked list of results. In some examples, merging and/or substitution of results may be used. The number of retrieved results may be displayed at the graphical user interface as at item 106 in FIG. 1.

Results that are popular within the Enterprise may be presented in area 108 of the display. For example, the information retrieval system has access to click graphs and uses the click graph to find results which are frequently clicked (or selected in other ways) by end users within the Enterprise. A click graph is a collection of nodes connected by edges. Each node represents a query or a document. An edge connects a query node and a document node when the query has been observed, by the information retrieval system, to give rise to a click on that document. Edges may be weighted according to a frequency of observed click events for the given query-document pair. Separate click graphs may be maintained for Enterprise search data and for other search data. Alternatively, clicks by end users within the Enterprise may be given higher weight so that the edges of a click graph storing both Enterprise and non-enterprise data are influenced accordingly.

As illustrated in FIG. 1 region 108 shows one result 110 comprising an address 112 such as a uniform resource locator (URL) of a web page, document or other result item, snippet text 114 such as an extract of text from the result, and a flag field 116, a note field 118 and a readers field 120. The flag field holds a number indicating how many flags are allocated to the result. The note field 118 holds a number indicating how many notes have been stored in relation to the result. The readers field 120 holds a number indicating how many readers of the result there are from within the group, for example, where the result is a blog. The readers field gives the end user an indication as to whether his or her co-workers find the item interesting. Additional results 122, 124 may also be displayed where these results are not popular results within the Enterprise.

Results may comprise end user results. As illustrated in FIG. 1 three end user items 132, 142, 150 are included in the results list. In this example each end user item comprises a photograph of the end user, a name of the end user and a title of the end user. Next to each end user item, information may be displayed about why the end user is relevant to the query terms. For example, a “colleagues who know” section 130 of the graphical user interface display of FIG. 1 includes two end user results. One of these comprises a photograph 132, a name 134, a title 136 and indicates that the end user has 5 related flags 138 in respect of the query terms and has one related answer 140 in respect of the query terms. A second end user result comprises a photograph 142 with a name, title and one note related to the query terms.

A related questions 144 area of the display comprises a text input box 146 where an end user is able to input a question to be sent to the colleagues listed on this display 100. To send the question the end user is able to select the ask button 148. This causes the information retrieval system to generate and send a message, via email, chat, SMS or in other ways to those end users identified on the display 100.

Under the related questions area of the display is another end user result comprising photograph 150 with associated name and title. This end user previously submitted a query 152 to the information retrieval system which is similar to the query terms currently input by the end user. The previous query 152 may be displayed together with information about when that query was made. Information 154 about how many others follow a blog of the end user and how many answers 156 the end user has given to questions submitted via the information retrieval system may also be given.

By arranging the information retrieval system to index end user records it is possible to include end user results together with other results as shown in FIG. 1. End user records may be created and stored by the information retrieval system or may be accessed from another entity which manages the end user records. An end user record may comprise a photograph, name, title, flag details, query history, follow details, notes, answer history, position within group (organizational position), physical location, and other data. An end user record may also comprise one or more topics that the end user is associated with, as identified by the topic analysis component. The information retrieval system may use a ranking algorithm which takes into account one or more fields of the end user records.

By including end user results together with other results as shown in FIG. 1 an end user quickly finds other end users in his or her group (enterprise or other organization) with whom he may collaborate to find information and so complete a task. The end user quickly finds information that others in his group accessed in relation to the same or a similar query. For example, the results in the popular results section 108. The ranking algorithm or other selection process may take into account physical location of the end users and/or organization position of the end users. In this way an end user quickly finds others users, who are in the same group or team, and who are likely to have knowledge or skills to help with a task related to a query the end user input. Other users who are in the same physical location and who are likely to be able to help are also found.

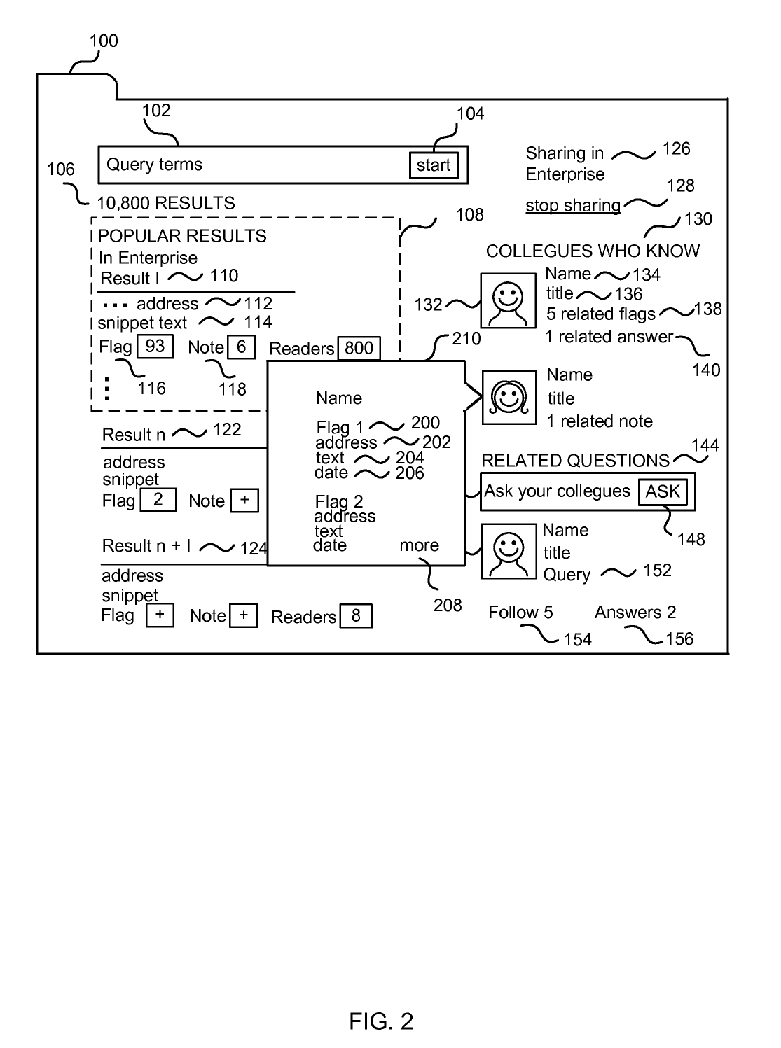

FIG. 2 is a schematic diagram of the graphical user interface display of FIG. 1 with a pop up detail 210. A pop up window is indicated next to end user photograph 142 and shows how more information about that end user result may be viewed by moving a mouse over the end user photograph. The information in the pop up window includes a number of flags 200 the end user has assigned to web pages, an address 202 such as a URL of a web page that the end user has flagged, extract text 204 from the flagged web page; and a date 206 when the web page was flagged by the end user. Similar information may be given for one or more other web pages the end user has flagged. For example, a second flag and associated information is given in FIG. 2. To view more detail about the end user a “more” link 208 may be selected.

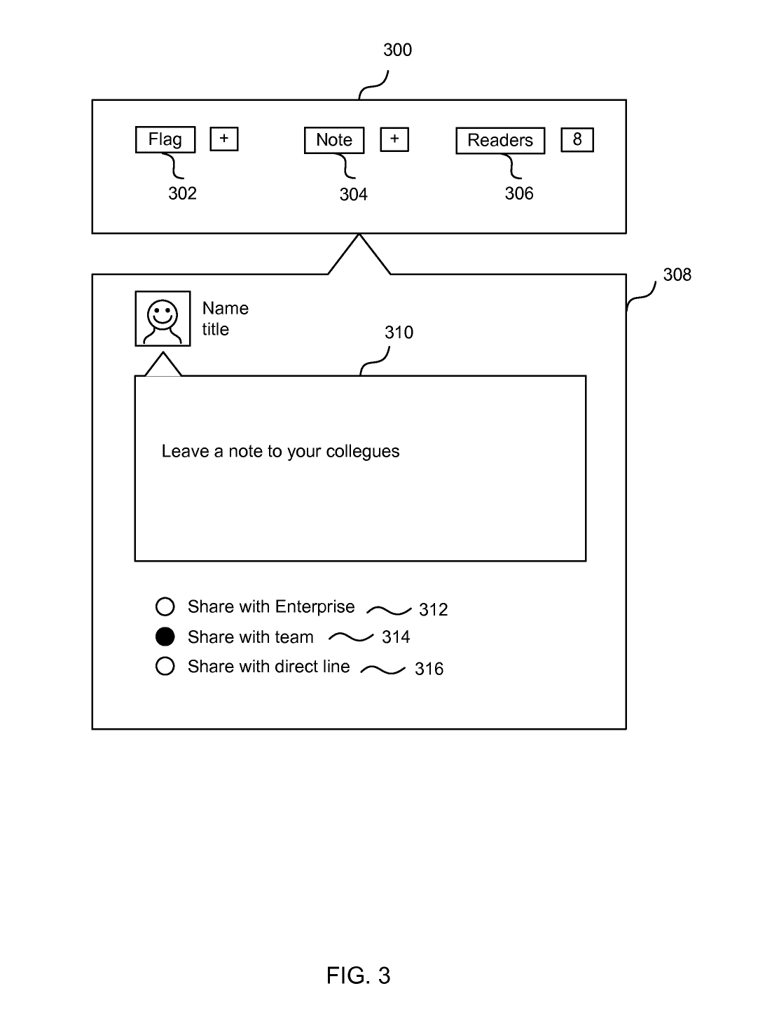

FIG. 3 is a schematic diagram of a graphical user interface display for leaving a note and specifying sharing permissions. The information retrieval system is arranged to serve a graphical user interface to client terminals which comprises displays such as that of FIG. 1 and FIG. 2. The information retrieval system is able to detect when an end user is carrying out research by viewing documents, blogs, web pages, emails or other information. For example, the information retrieval system uses the URL data from the web browser at the client terminal where end users have given consent for this. It applies rules or other criteria to the URL data to detect when an end user is using the information retrieval system to carry out research as opposed to administrative or other tasks. For example, key word matching against the URL data may be used to distinguish between administrative web pages and research web pages. The information retrieval system may also use other information such as user input data to determine whether a uses is carrying out non-research tasks such as data entry, upload or download of documents, generating documents and other non-research tasks. Time intervals between user input data events and other time and date data may also be used. Combinations of any one or more of key word matching against URL data, user input data, time data may be used.

When the information retrieval system detects research activity at an end user terminal it causes a request for a note to be displayed at the end user terminal as indicated in FIG. 3. FIG. 3 shows part of a graphical user interface display comprising a tool bar 300 which pops up when the information retrieval system detects research activity. The pop up tool bar 300 may superimpose other information on the display. The pop up tool bar 300 comprises a flag button 302, a note button 304, a readers button 306. Next to each button is a display indicating a frequency. In this example there are 8 readers of the web page currently being displayed at the end user web browser. At present the end user has not assigned any flags to the web page and has not left any notes regarding the web page.

When the end user selects the note button 304 a second pop up window 308 is displayed with a photograph of the end user (end user) and his or her title. The end user is prompted to leave a note to his or her colleagues at input box 310. The end user may enter text at input box 310 and the information retrieval system stores the text in a note record. The note record may be linked to one or both of the web page and the end user record. Stored with, or linked to, the note record is at least one sharing permission which may be specified by the end user. In the example of FIG. 3 the end user is able to select one or more of three sharing permissions which are: share with all those in the enterprise of the end user 312, share with a team that the end user is a member of 314, and share with those whom the end user manages on a direct line relationship 316.

The information retrieval system may be arranged to apply a filter to a ranked list of results it calculates from an index of items. The filter may take into account the sharing permissions mentioned above. In this way results with notes are available to end users with appropriate permissions but not to other end users. That is, in some example, a whole result including any note is blocked if sharing permissions indicate that sharing is not permitted. In other examples, only a note part of the result may be blocked.

It is also possible for the ranking algorithm itself to take into account the sharing permissions. In this case filtering of the ranked results list with regard to note sharing permission is not required.

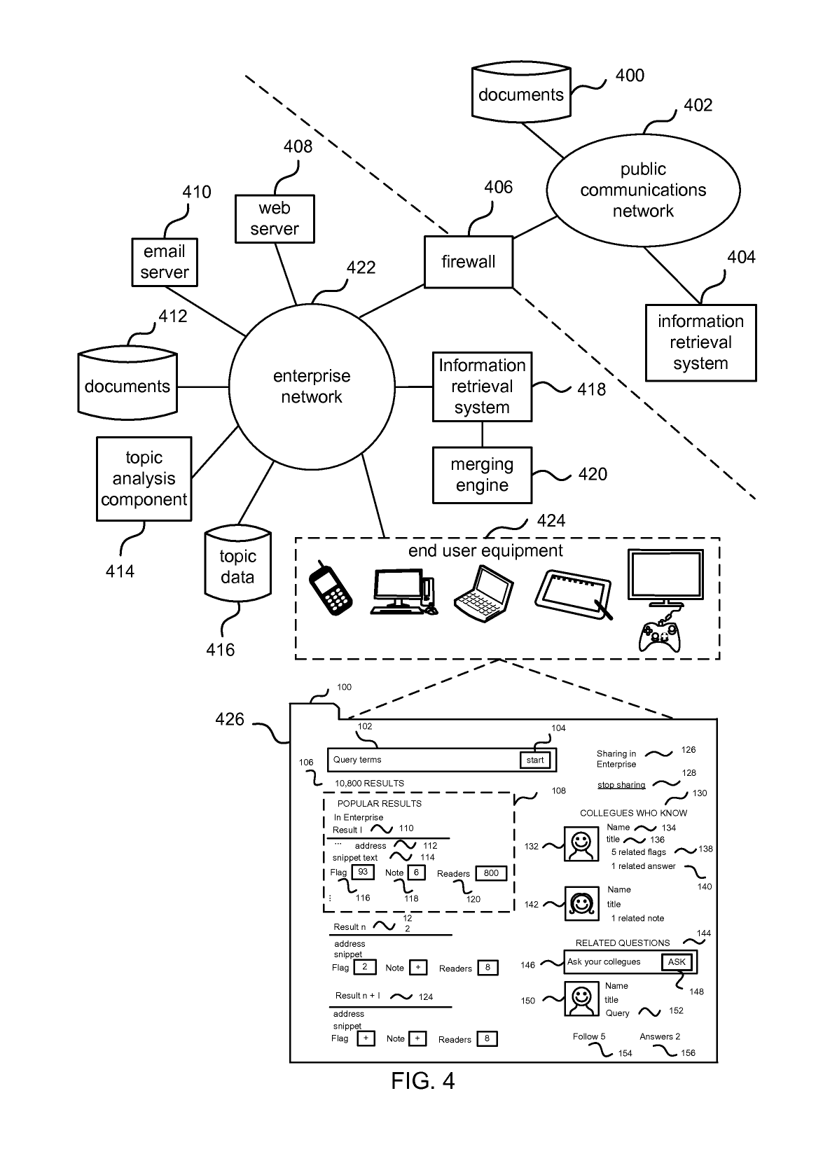

FIG. 4 is a schematic diagram of an enterprise network 422, suitable for implementing the graphical user interface display of FIGS. 1 and 2, connected via a firewall 406 to a public communications network 402. This is an example only. It is also possible to implement the methods described herein at an information retrieval system such as information retrieval system 404 at public communications network 402.

FIG. 4 shows a single firewall 406 for clarity although in practice multiple firewalls in more complex arrangements may be used. Behind the firewall the enterprise network 422 comprises a plurality of computing devices connected to one another using fixed wired and/or wireless communications links. Each entity in the enterprise network may have an address such as an IP address which is private with respect to entities in the public communications network. In contrast, entities in the enterprise communications network may know IP addresses of entities in the public communications network.

The enterprise network comprises one or more sources of documents 412 such as web servers 408, databases, electronic archives, email servers 410, and other sources. Many of these documents may be private with respect to the public communications network.

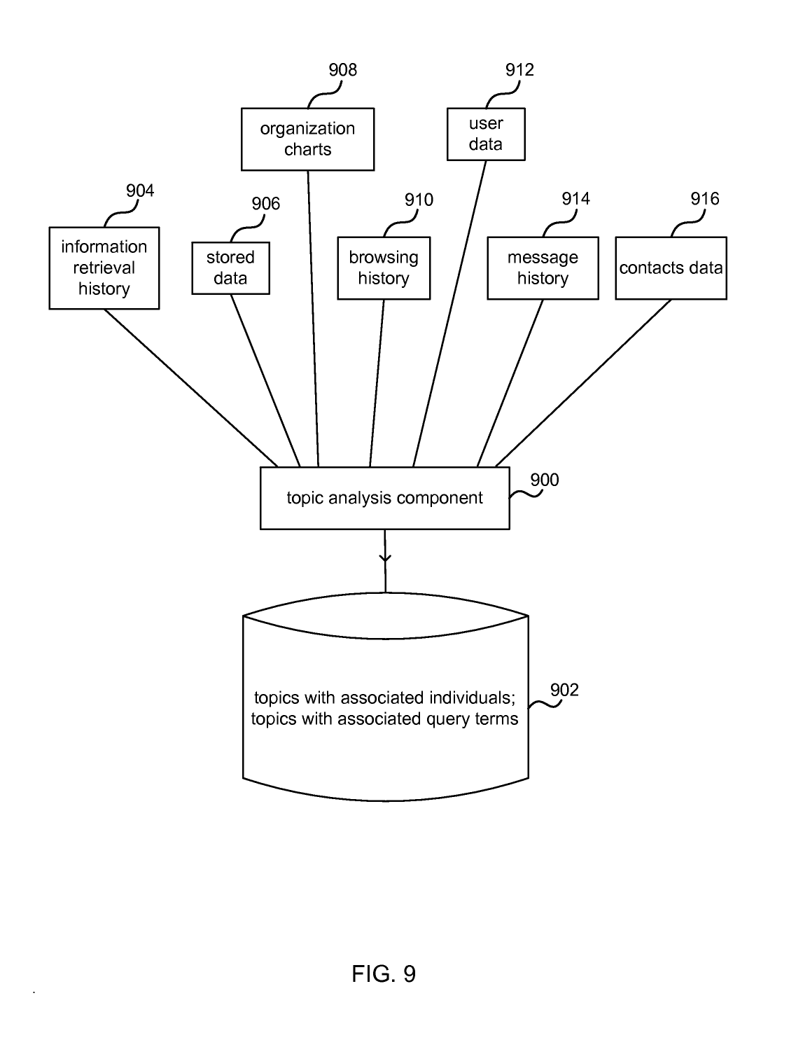

The enterprise network has a topic analysis component 414 which is computer implemented using software and/or hardware. In FIG. 4 the topic analysis component is shown as a stand-alone entity for clarity. However, the topic analysis component may be integral with the information retrieval system 418 or another entity in the enterprise network 422. The topic analysis component is described in more detail with reference to FIG. 9 below. Results from the topic analysis component may be stored in a topic data 416 database at any location in the enterprise network 422.

The enterprise network has an enterprise information retrieval system 418 and integral merging engine 420. The enterprise information retrieval system is able to carry out a search to retrieve results from both the enterprise network and the public communications network 402. This may be achieved in a variety of ways. For example, the enterprise information retrieval system may crawl both the enterprise network and the public communications network and calculate an index of documents it finds during the crawl. A ranking algorithm is then used to retrieve a ranked list of documents from the index according to a query submitted by an end user within the enterprise network 422. The ranking algorithm and/or index may take into account topic data and enterprise user data which is private to the enterprise network 422.

In another example the enterprise information retrieval system submits a query that it receives to the public information retrieval system 404 and any other information retrieval systems in a manner which is not visible to the end user. The enterprise information retrieval system has its own index of documents from the enterprise network. It retrieves a ranked list of documents from its own index; a ranked list of documents from the public information retrieval system, and a ranked list of documents from any other information retrieval systems. The ranked lists of documents are then merged by the merging engine 420 in an intelligent manner before being returned to the end user. The merging engine 420 is able to use topic data and enterprise user data which is private to the enterprise network 422. The ranking algorithm to retrieve a ranked list from the enterprise information retrieval system index may use topic data and enterprise user data; however, the ranking algorithms external to the enterprise network may not.

The end user may use any suitable computing device to access the enterprise information retrieval system 418. For example, a variety of end user equipment 424 is illustrated in FIG. 4. The end user equipment comprises a web browser or other means to enable a graphical user interface to the enterprise information retrieval system 418 to be displayed as indicated in FIG. 4. The graphical user interface displays may be similar to those shown in FIGS. 1, 2 and 3.

In some embodiments the enterprise information retrieval system 418 and merging engine 420 are omitted. The public information retrieval system may be arranged with a plurality of pipelines, one for public use and others which are allocated to users of specified groups such as enterprises or other organizations. A pipeline is a series of data processing stages from input to output. A pipeline of an information retrieval system comprises an input which receives query terms and various stages which generate as output a ranked list of results retrieved from an index of documents (or other items) using a ranking algorithm.

One or more of the pipelines may be arranged so that confidential data such as end user records of an enterprise (or other organization or group), topics of an enterprise, browsing records of the enterprise and other confidential enterprise data is kept private and secure. By having one or more secure pipelines of the information retrieval system, end users of an enterprise or other organization are able to benefit from information retrieval results which are more relevant and which facilitate collaboration. This is achieved without the need for a dedicated enterprise information retrieval system and associated merging engine. As a result the amount of communications bandwidth required is reduced because federated search from the enterprise information retrieval system is not required.

In order that the public information retrieval system is able to route incoming queries to the appropriate pipeline a user authentication and attribution stage may be used. This may involve a password entry system whereby an end user logs in to the information retrieval system using a password or other trusted identifier that he or she has previously created during a registration process. In some examples a routing engine at the public information retrieval system may map session ids of incoming queries to IP addresses of end user equipment. The IP addresses may be mapped to enterprises or other organizations or groups using a look up table or similar arrangement, for example, checking for IP ranges known to be associated with a particular enterprise.

If an end user makes a user input instructing the information retrieval system to “stop sharing” this may trigger the routing engine to route queries associated with a particular session ID to a public pipeline. That is, the routing engine may route browsing sessions between pipelines according to user input.

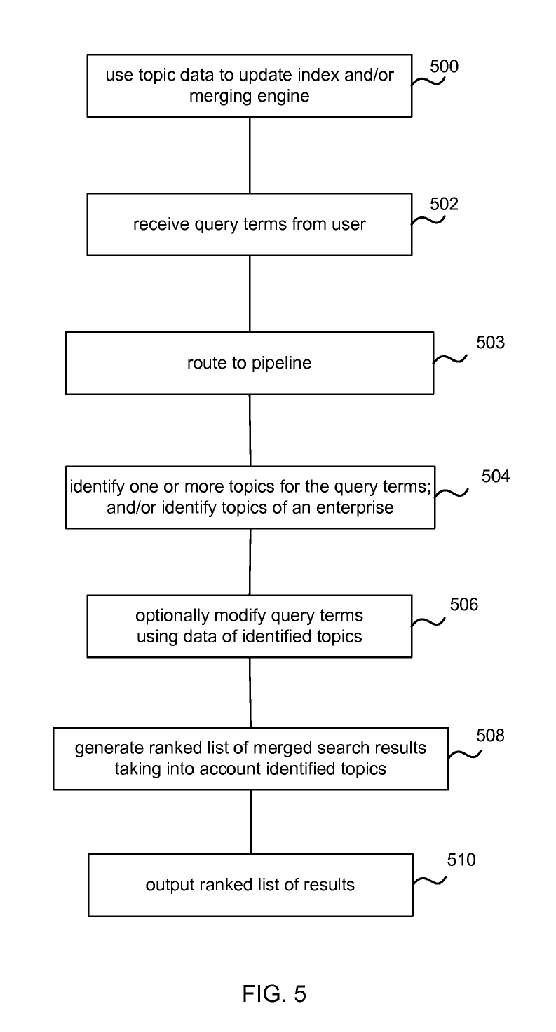

FIG. 5 is a flow diagram of an example method of operation at an information retrieval system which may be a public information retrieval system or a private information retrieval system at an enterprise or other organization. The information retrieval system has access to topic data as described above. It uses the topic data to update 500 an index of documents or other items in some examples. Additionally or alternatively it may use the topic data to update a merging engine where a merging engine is used. The topic data comprises topics of an enterprise or other organization or group; and end users associated with the topics. Enterprise user data may also be used to update the index and/or merging engine. For example, enterprise user data may be recency information, information about flags a user has assigned to a document, information about notes a user has written for a document, information about readers of a document, information about queries the user has made which are related to the current query, information about answers the user has given to the current query.

The information retrieval system receives 502 query terms input by a user (who is previously authenticated and attributed to an enterprise or other group) and sent to the information retrieval system from a client terminal, for example, using a web browser. The information retrieval system routes 503 the query to one of a plurality of pipelines, in the case that pipelines are being used. The routing is on the basis of information identifying an enterprise or other organization that the query is issued from. The information retrieval system identifies 504 one or more topics that potentially apply to the query terms. This is done using key word matching between the query and key words associated with topics of the enterprise or other topics.

The information retrieval system optionally modifies 506 the query terms using data from the identified topics. For example, if the query terms are ambiguous because they are associated with two or more potential topics, the information retrieval system may add a query term which is associated with one of the topics, where that topic is a topic of the enterprise and the other topics are not.

The modified query is used in federated search for embodiments using federated search.

The modified query is applied 508 to a ranking algorithm to retrieve a ranked list of results. The ranking algorithm may take into account the identified topics. The ranking may alternatively, or in addition, take into account user data.

The information retrieval system outputs 510 a ranked list of results.

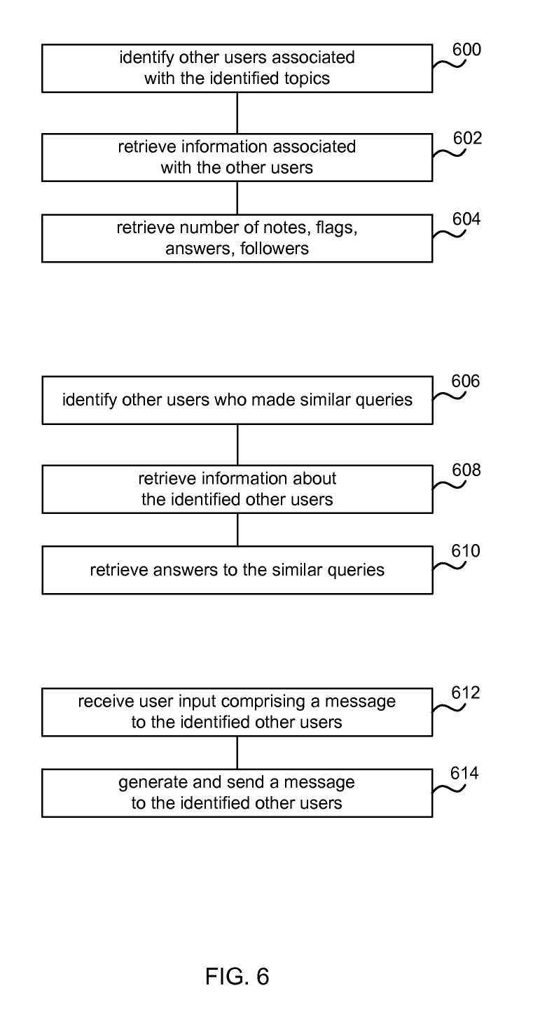

FIG. 6 is a flow diagram of three methods at an information retrieval system which may be carried out in conjunction with the method of FIG. 5. Once one or more topics have been identified at step 504 of FIG. 5 the information retrieval system may continue to identify 600 end users (users) associated with those topics. This is achieved using output from the topic analysis component. The information retrieval system may apply a ranking algorithm or other process to calculate a ranked list of the identified end users most related to the query. The ranking process may also take into account physical and/or organizational proximity between the end user issuing the query and end user records being retrieved. The information retrieval system may retrieve 602 information about the identified end users, for example, from end user records. The information from the records may comprise numbers of notes, flags, answers, followers of the end users.

By taking into account physical and/or organizational proximity then colleague engagement is facilitated by considering not only “who knows what” but also “who knows who” and “who is near whom”. In some examples, the information retrieval system may retrieve contacts from outside the group, for example, by searching professional and social networking system contacts of an end user. In this case the information retrieval system may issue queries to professional and/or social networking systems and receive lists of contacts as a result. The lists of contacts may then be analyzed and merged with results of the information retrieval system.

The information retrieval system, once it has a query from an enterprise user, may identify 606 other users. The query may be thought of as a signal which enables the information retrieval system to understand user intent and match-make a relevant colleague; and also as a signal which enables the information retrieval system to classify the user who issued the query in terms of what are his interests and what he is knowledgeable about.

The match-making process may comprise using end user records (also referred to as user profiles). An end user record may hold an activity log for the associated user which stores any one or more of: details of web browsing history, email history, internal (within the group) telephone call history, search query history and other data. An end user record may also store topic data holding results from the topic analysis component (or from other sources) indicating what the user is an expert on or is knowledgeable about. An end user record may be formed using internal work call logs (to see relations), corporate emails, IM, SMS, documents and anything that is web related—such as search terms but also regular web browsing. The end user records may be created by the topic analysis component or any other suitable entity. A filter may be used to filter out end user data which is not relevant to the group. For example, in the case of an enterprise, then end user activity data which is not relevant to the enterprise's line of business may be filtered out.

On the basis of the end user records, and given a search interaction of a user, the information retrieval system match-makes colleagues that are potentially able to help with the task the end user is working on.

For example, when Alice is searching for “SOME SEARCH TERM” then the system searches for the best end user record (profile) that can help her such that it also adheres to the best likelihood she will also feel comfortable to approach the person whose end user record is found. Bob might be more knowledgeable than Cathy but Cathy is in the same floor as Alice while Bob lives in another continent. If Cathy is ‘good enough’ to help Alice the information retrieval system may rank her higher than Bob.

In this way inter-corporate social interaction and better knowledge-flow between workers is facilitated.

In some examples, the match making is achieved by indexing the end user records as part of the information retrieval system index. However, this is not essential; other ways of searching the end user records to find relevant colleagues in response to query terms may be used. Once relevant end user records are found, information from the end user records may be retrieved 608 and this may include answers the end users have previously given in respect of the related queries.

The information retrieval system may receive 612 user input comprising a message to the identified other users. In response it generates and sends 614 a message to the identified other users. In other examples, the information retrieval system sends the query to the identified other users.

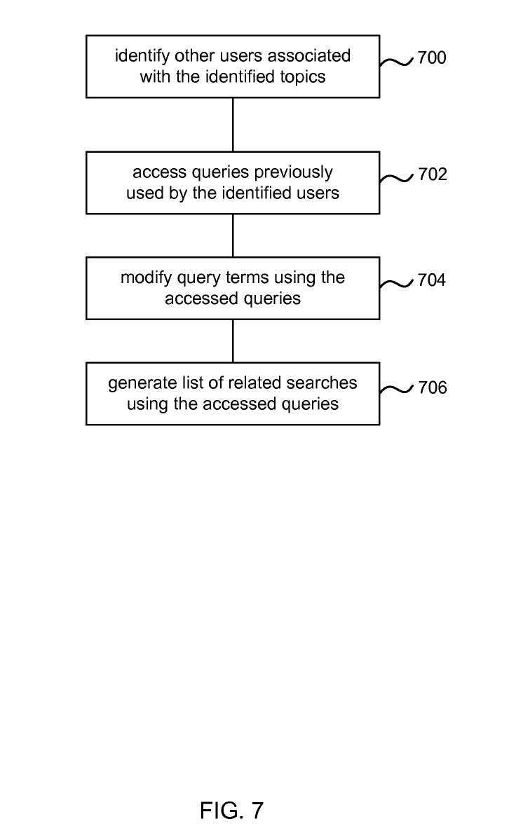

FIG. 7 is a flow diagram of a method of query modification which may be carried out by the information retrieval system. Topics are identified, either for an enterprise as a whole, or for an incoming query, and the identified topics are used to find 700 other users associated with those identified topics. Queries previously input by those users are found 702 from query logs, end user records or other sources. The current query, which is currently passing through the information retrieval system process, may then be modified 704 by using key words from the identified previous queries. The information retrieval system may generate 706 a list of related searches using the accessed queries. For example, the information retrieval system may display the identified previous queries as part of a related searches list at a graphical user interface display.

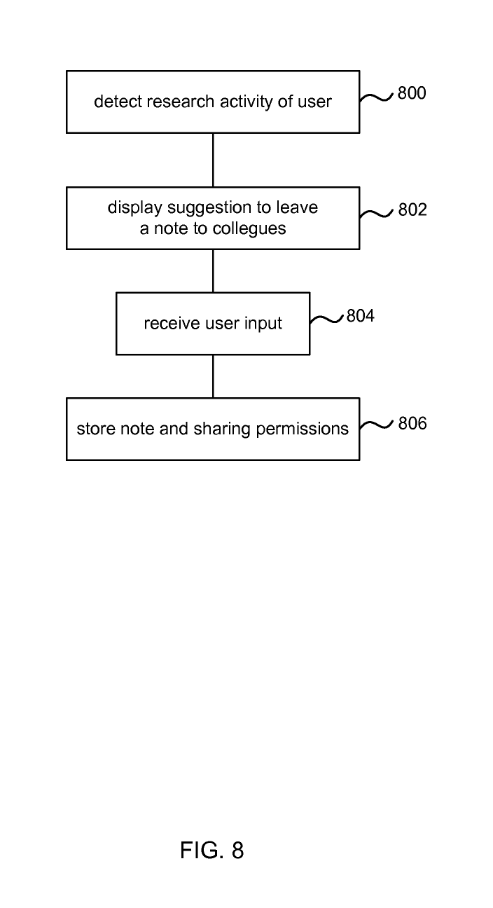

FIG. 8 is a flow diagram of a method of obtaining data to be shared and of storing associated sharing permissions. As described above with reference to FIG. 3 an information retrieval system may be arranged to detect 800 research activity of a user. When research activity is detected the information retrieval system may display 802 a suggestion to the user to leave a note to colleagues. User input may be received 804 in response. The user input may include a note and sharing permissions for the note. The information retrieval system stores 806 the note and the sharing permissions. For example, the note is stored in an end user record of the end user who input the note. In another example the note is stored by modifying the document (that the note is about) so that it includes a field storing the note and the sharing permissions.

FIG. 9 is a schematic diagram of inputs to a topic analysis component. These inputs comprise one or more of: information retrieval history 904, stored data 906, organization charts 908, browsing history 910, user data 912, message history 914, contacts data 916. The input sources to the topic analysis component comprise data which is aggregated so that individual user data is not present, and/or data which users have given consent to be used. For example, the information retrieval history data 904 may comprise click graphs, query logs and other information retrieval data. Browsing history 910 may comprise browsing history of individuals and/or aggregated browsing history of groups of individuals. Message history 914 may comprise data about emails, chat, SMS or other messages sent and received by individuals or groups of individuals.

The input sources to the topic analysis component may be specific to a specified enterprise, organization or other group of end users. The input sources are used to form a plurality of descriptions of events, each description comprising a plurality of features. For example, an event may be a query input to an information retrieval system or a message that is sent.

The topic analysis component uses a clustering process to find topics 902 associated with the enterprise. For example, queries issues to the information retrieval system throughout an enterprise, in a given time period, may be used by the topic analysis component to form a plurality of clusters. Each cluster comprises a plurality of queries. Once the clusters are formed the key words of the clusters may be used to assign semantic meanings to the clusters.

The topic analysis component may be arranged to cluster end users. For example, features of end users such as data from the organization charts, data from the browsing history, data from information retrieval history, data from contacts and other user data may be used to find clusters of end users. The end user clusters may be assigned one or more topics by analyzing features of the end users in that cluster.

The topic analysis component may be arranged to cluster queries. Features of queries such as key words, time data, data about a user issuing the query, data about other users who issued similar queries and other features may be found. Using the features the queries are clustered. The query clusters may be assigned topics by looking at features of queries in each cluster.

Any suitable clustering process may be used such as k-means, latent Dirichlet allocation (LDA) a classification tree created using term frequency—inverse document frequency (TF/IDF), a hierarchical classification system as described in US Patent publication 20110282858 or a categorization system as described in US patent publication 20120166441, or others.

In an example an LDA process is used whereby a large sparse matrix is formed, with each column of the matrix representing a user and each row of the matrix representing a query term or other feature associated with the user. The other features associated with the user may be features of interactions of the user with other systems such as email systems, company applications, document repositories, customer relationship management systems and others. The LDA process calculates two dense matrices from the large sparse matrix such that the two dense matrices, when multiplied together approximate the large sparse matrix. One of the dense matrices represents each user by a row and its columns represent topics found by the LDA process. The other dense matrix represents each query term or other feature by a column and its rows represent the topics.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs).

In an example, the information retrieval system is arranged to receive user input comprising a question; to generate a message comprising the question and to send the message to at least one end user associated with the at least one end user record.

In some examples the information retrieval system is arranged to generate a message comprising the query terms and send the message to at least one end user associated with the at least one end user record.

The information retrieval system may identify other end users of the group on the basis of end user records of the end users of the group, the end user records comprising historical activity data and the information retrieval system may output information about the identified other end users.

An example comprises finding, from the stored topic data, at least one topic associated with the query terms, and identifying other end users of the group who are associated with the at least one topic.

An example comprises accessing queries previously submitted to the information retrieval system by the identified other end users of the group.

An example comprises modifying the query terms using the accessed queries.

An example comprises generating a list of related searches using the accessed queries.

An example comprises calculating the stored topic data by using features of observed interactions of end users of the group with the information retrieval system or with other systems.

In an example, a computer-implemented method of information retrieval comprising: enabling access to an information retrieval system only by end users who are members of a specified group;

storing topic data comprising information about a plurality of topics and about associations between the topics and the end users;

calculating a ranked list of search results from a plurality of potential results, on the basis of the topic data and query terms input by a first one of the end users; wherein the potential results comprise at least some end user records and wherein the ranked list of search results comprises at least one end user record.

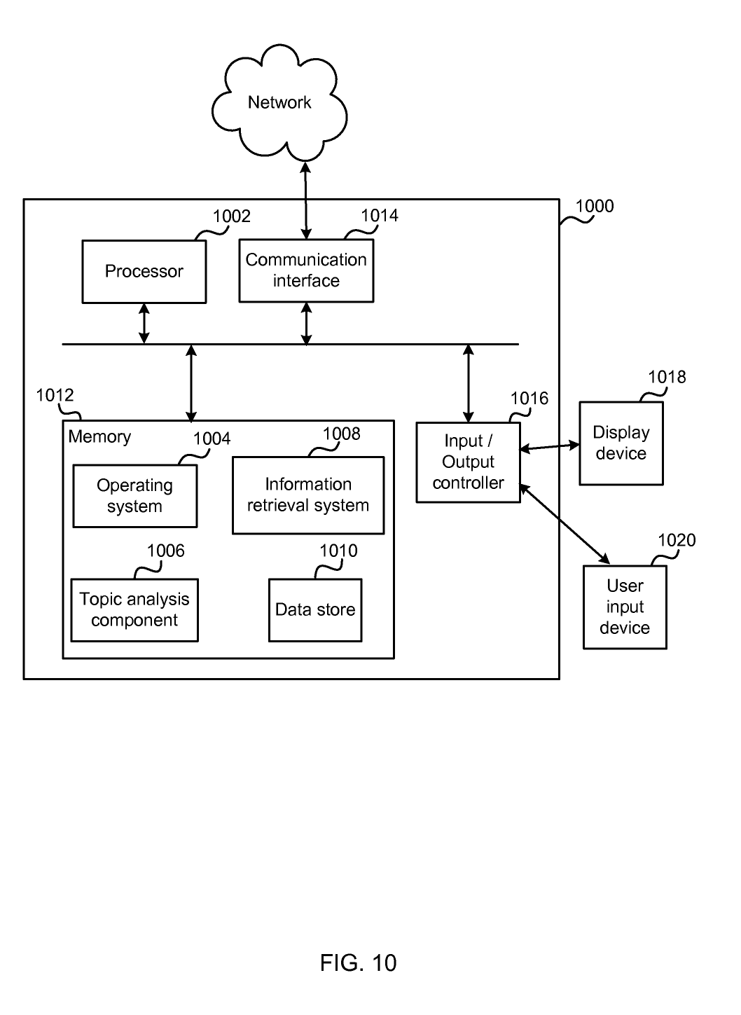

FIG. 10 illustrates various components of an exemplary computing-based device 1000 which may be implemented as any form of a computing and/or electronic device, and in which embodiments of an information retrieval system may be implemented.

Computing-based device 1000 comprises one or more processors 1002 which may be microprocessors, controllers or any other suitable type of processors for processing computer executable instructions to control the operation of the device in order to carry out any of the methods described herein. In some examples, for example where a system on a chip architecture is used, the processors 1002 may include one or more fixed function blocks (also referred to as accelerators) which implement a part of the method of any of FIGS. 5 to 8 or any other methods described herein in hardware (rather than software or firmware). Platform software comprising an operating system 1004 or any other suitable platform software may be provided at the computing-based device to enable application software to be executed on the device. A topic analysis component 1006 may be provided as well as an information retrieval system 1008. A data store 1010 holds topics, end user records, click graphs, queries, and other data.

The computer executable instructions may be provided using any computer-readable media that is accessible by computing based device 1000. Computer-readable media may include, for example, computer storage media such as memory 1012 and communications media. Computer storage media, such as memory 1012, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 1012) is shown within the computing-based device 1000 it will be appreciated that the storage may be distributed or located remotely and accessed via a network or other communication link (e.g. using communication interface 1014).

The computing-based device 1000 also comprises an input/output controller 1016 arranged to output display information to a display device 1018 which may be separate from or integral to the computing-based device 1000. The display information may provide a graphical user interface. The input/output controller 1016 is also arranged to receive and process input from one or more devices, such as a user input device 1020 (e.g. a mouse, keyboard, camera, microphone or other sensor). In some examples the user input device 1020 may detect voice input, user gestures or other user actions and may provide a natural user interface (NUI). This user input may be used to input queries, specify rules, criteria, thresholds, set up routing criteria to route queries to pipelines, or for other purposes. In an embodiment the display device 1018 may also act as the user input device 1020 if it is a touch sensitive display device. The input/output controller 1016 may also output data to devices other than the display device, e.g. a locally connected printing device.

Any of the input/output controller 1016, display device 1018 and the user input device 1020 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computer-implemented method of information retrieval comprising:
at a processor, enabling access to an information retrieval system only by end users who are members of a specified group;
storing topic data comprising information about a plurality of topics and about associations between the topics and the end users; and
calculating a ranked list of search results from a plurality of potential results, on the basis of the topic data and query terms input by a first one of the end users.

2. The method of claim 1 wherein the information retrieval system is a first pipeline of a plurality of information retrieval pipelines and the method comprises routing the query terms into the first pipeline only when the query terms have been received from an end user of the specified group.

3. The method of claim 1 comprising monitoring input of an end user at an interface to the information retrieval system and detecting research activity of the first end user on the basis of the monitored input.

4. The method of claim 3 comprising detecting research activity by using any one or more of:
key word matching against URL data, user input data, time data.

5. The method of claim 3 comprising, when research activity of the first end user is detected, generating a prompt to prompt for user input, and if the prompted user input is received, storing data and sharing permissions for the data according to the user input.

6. The method of claim 5 comprising storing the data and sharing permissions at any of:
an end user record of the end user, a document which was subject of the research activity.

7. The method of claim 1 wherein the plurality of potential results comprise at least one end user record.

8. The method of claim 1 wherein the plurality of potential results comprise a plurality of contacts of the first end user obtained from a social or professional networking system.

9. The method of claim 1 wherein the ranked list of search results comprises at least one end user record.

10. The method of claim 9 comprising receiving user input comprising a question; generating a message comprising the question and sending the message to at least one end user associated with the at least one end user record.

11. The method of claim 9 comprising generating a message comprising the query terms and sending the message to at least one end user associated with the at least one end user record.

12. The method of claim 1 comprising identifying other end users of the group on the basis of end user records of the end users of the group, the end user records comprising historical activity data and outputting information about the identified other end users.

13. The method of claim 1 comprising, finding, from the stored topic data, at least one topic associated with the query terms, and identifying other end users of the group who are associated with the at least one topic.

14. The method of claim 13 comprising accessing queries previously submitted to the information retrieval system by the identified other end users of the group.

15. The method of claim 14 comprising modifying the query terms using the accessed queries.

16. The method of claim 13 comprising generating a list of related searches using the accessed queries.

17. The method of claim 1 comprising calculating the stored topic data by using features of observed interactions of end users of the group with the information retrieval system or with other systems.

18. The method of claim 1 at least partially carried out using hardware logic.

19. A computer-implemented method of information retrieval comprising:
enabling access to an information retrieval system only by end users who are members of a specified group;
storing topic data comprising information about a plurality of topics and about associations between the topics and the end users; and
calculating a ranked list of search results from a plurality of potential results, on the basis of the topic data and query terms input by a first one of the end users; wherein the potential results comprise at least some end user records and wherein the ranked list of search results comprises at least one end user record.

20. A computer-implemented information retrieval system comprising:
an access control mechanism arranged to only enable access to the information retrieval system by end users who are members of a specified group;
a store of topic data comprising information about a plurality of topics and about associations between the topics and the end users; and
a processor arranged to retrieve a ranked list of search results from a plurality of potential results, on the basis of the topic data and query terms input by one of the end users.
